(19) United States
(12) Patent Application Publication
(10) Pub. No.: US 2002/0049982 A1
(43) Pub. Date: Apr. 25, 2002

(54) Integrated book-marking system for existing set-top boxes including those without browsing capabilities and those unable to expand to support browsing or interactive linking

(76) Inventor: Dan Kikinis, Saratoga, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/947,286

(22) Filed: Sep. 5, 2001

Related U.S. Application Data
(60) Provisional application No. 60/230,148, filed on Sep. 5, 2000.

(51) Int. Cl. H04N 7/173

(52) U.S. Cl. 725/110; 725/111; 725/112

(57) ABSTRACT

Integrated Book-Marking System for Existing Set-Top Boxes including Those Without Browsing Capabilities and Those Unable to Expand to Support Browsing or Interactive Linking

The present application claims priority to the provisional filed application entitled Integrated Book-Marking System for Existing Set-Top Boxes including Those Without Browsing Capabilities and Those Unable to Expand to Support Browsing or Interactive Linking, filed on Sep. 5, 2000, serial No. 60/230,148, which is also incorporated herein by reference.

### BACKGROUND

In many cases, set-top boxes that are deployed in the field have extremely limited capabilities in terms of memory, CPU power, etc., and in terms of back-channel communication, such as early 300-, 1200-, or 2400-baud modems for back-channel communication via telephone lines. Furthermore, in many cases, households have only a single phone line, so the usage of the phone line for extended periods of time by a set-top box is not acceptable.

What is needed is a system and a method that allow users even in such situations to interactively show interest in items, and to be notified, or receive information, about requested items, and to be able to conduct e-business.

### DESCRIPTION OF THE EMBODIMENT

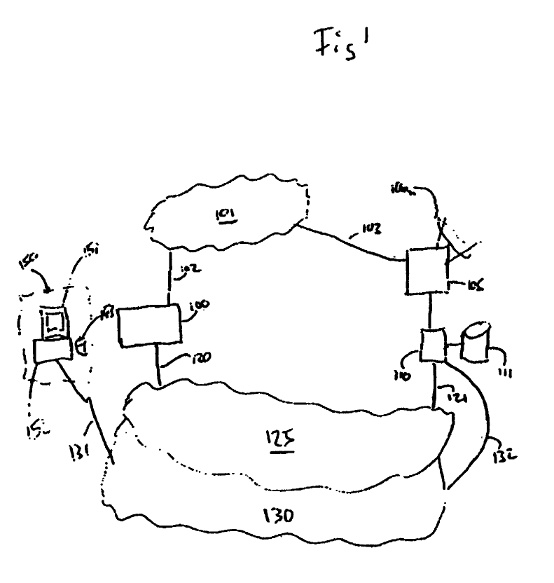

FIG. 1 shows an overall view of the description according to this embodiment. Set-top box 100, for example, is connected via broadcast system 101, local connector 102, and uplink 103 to head-end 105. Broadcast system 101 may consist, for example, of a satellite system, in which case connector 102 would consist of a satellite dish, etc. In other cases broadcast system 101 may be a terrestrial broadcast system, and local connector 102 would be an antenna. In yet other cases, broadcast system 101 may be a regular cable system with cable distribution, and local connector 102 would then be a hook-up for the house. In yet other cases, broadcast system 101 may be a combined system of, for example, satellite plus local TV via antenna, or cable system plus satellite, or cable system plus aerial, or any combination thereof.

Naturally, it is clear that set-top box 100 is connected, directly or otherwise, to a viewing system such as a TV, projection screen, etc. (not shown), as is customary and well-known in the art. Typically, a remote control, either a multi-function combination model or a simple model that controls only the set-top box, can be used to control the novel functions of this embodiment.

Many such existing systems include a back-link 120, which typically dials through a phone system 125. In some cases there is an Internet connection through Internet 130; in other cases there is a dedicated phone connection to server 110 with mass storage 111.

Those links are used, for example, to renew keys for programming setup, and occasionally to identify whether the box is installed in the correct location as licensed for use. In some cases, for example in the case of a satellite system, to decide which channels can be viewed and which not in accordance with FCC rules, etc.

Typically, such boxes connect once a day, or once every few days, to a toll-free or local number for transmitting and/or receiving a few short blocks of data that are then managed by server 110 and use database 111. Obviously, there may be more than a single server, and there may be more than a single database, but for purposes of simplicity in the current embodiment, only one of each is shown here.

The server is also connected to head-end 105. This connection allows broadcasting of certain commands, such as, for example, requesting a dial-up, etc., over the broadcast channel to set-top box 100.

The user of set-top box 100 may, in many instances, also own or have access to a PC, such as is shown as element 150, consisting of a monitor or display 151, and box 152, generally called a CPU box (main unit), which includes mass storage unit 153 that contains software, data, etc. PC 150 typically has a link 131 available to Internet 130, in some cases via phone line, in other cases via DSL or cable modem or any other kind of connection that is well known in current art. In some cases, the PC may be actually available at a workplace, rather than at the home.

While viewing a program, whenever a user sees an item of interest, the user can push a specific button on the remote control (typically remote controls have several special buttons that are not always used), causing the set-top box to record the time when that specific button was pushed and the channel being viewed at that time. Additionally, when multiple user IDs are programmed into a set-top box, the box can then record currently selected user ID.

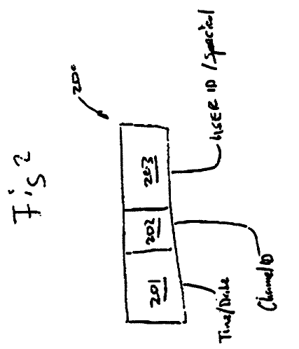

During the next regularly scheduled call-in by the set-top box (that is, the next time the set-top box connects to server 110), in addition to its regular communications, the set-top box now adds some additional blocks to the transmission. FIG. 2 shows such a block 200 of an event where the user pushed a button at time and date 201. Channel ID 202 is shown, and record 203 could contain such data as user ID, if the box contains IDs of multiple users; which button was pushed, if more than one button is available; etc.

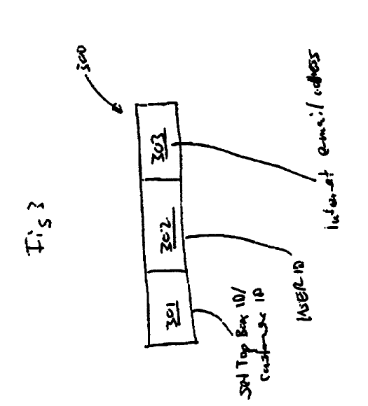

FIG. 3 shows a setup method that allows the user to establish multiple user IDs in block 300, by adding a transmission that includes an ID such as the set-top box ID, customer ID, or home phone number in element 301; the user ID in element 302 (e.g., bad, mom, sun1, girl2, etc.); and in field 303, an Internet email address where they want to receive any requested information, communications, etc.

This record 300 will, for example, only be sent when the box needs to be set up, such as before initial use. That is, if the user pushes a button before the box is programmed, a message may appear on the screen saying, “Please go to Setup and enter a user ID and email address.” When at least one user ID and email address has been entered, then the box is ready to use. The next time that the user pushes a button, a block of the type of block 200 will be sent in the following transmission sequence. In some cases, the box may be programmed to transmit this information immediately after any changes to its set up; in other cases, the box will wait until enough information has accumulated or until the next regularly scheduled transmission.

Depending on the usage agreement, and marketing techniques, the user may then receive, after each indication of interest in a product, service, or program, for example, an email containing links to specific relateed companies, offers, or general-interest items such as information, Web sites, etc. Those links may include a coded reference to the user, allowing the sender to trace the identity of the users who are actually using the transmitted references.

In some cases, the user may give permission to the operating company to allow third parties to send emails. In other cases, the user may be offered an option to keep his email address private and only receive those prepackaged mailings from the cable company. Even if the user restricts emails to only those from the cable company, the system is highly targeted, because it allows identification of each user and correlation with each item in which he has actively shown interest.

The currently described system takes advantage of sudden interest in an advertised product that leads to impulse buying. In marketing products such as, for example, a car, a house, or life insurance, impulse buying is much less important than in marketing less-expensive, disposable products. However, if a user sees an ad for a car that he likes, but he may not want to pursue it because he is in the middle of watching an interesting movie, and by the next day he has forgotten it, the present system allows advertisers to catch such cases.

The system can also be used in cases where the set-top box has interactive-commerce capabilities, but for the same reasons cited above, the user is not willing to interrupt his TV viewing experience, or to disturb other people viewing a TV event with him. In such cases, the user can instead discretely obtain information at a later date and peruse it at his leisure.

It is obvious that many modifications can be made, in particular to the records sent: The order of the data or the data included can be changed; other equivalent data may be used, as mentioned earlier: instead of the user ID, a telephone number may be used, a name, a social security number, or any other kind of ID. Instead of a user ID, a set-top box ID could be used, and instead of email, information could be sent as a message to a mailbox on the same set-top box via the broadcast system rather than just Internet mail.

So this embodiment is not limited to all the limited boxes, but can also have meaningful use for book marking things of interest during a program. For example, during a James Bond movie, a hot action scene shows Bond driving a BMW. If the user pushes a button during those sequences, for example, BMW may send an email to the user, or the user may receive an email or message pertaining to URLs or other links for BMW from the cable company or the content operator.

By tracking the time and channel at the moment when an expression of interest by a user is recorded, it is also possible for operators to obtain information about local distribution, by parameters such as ZIP code, phone number, etc., for local broadcasts that do not come over the same cable system. Additionally, in the case of localized advertisement, in which ads sometimes are split down to almost each block, by using the user or set-top box ID, the cable company can then figure out which ad was viewed by this user at that time on his box.

The capabilities of this embodiment can eliminate the “Oh, I forgot the name of that thing, but I really liked it” syndrome that very often happens during TV viewing, because, due to inertia, the viewer has no incentive to write down references when he's enjoying himself even when he has a strong interest in an item.

1. A method, comprising:
receiving an indication of interest for an item, the item being associated with an event, and the indication of interest being received from a user by the user clicking the item of interest with a cursor;
bookmarking the event by recording event data associated with the event, said recording in response to said receiving; and
processing the event data, said processing comprising:
searching for information related to the event; and
if the search is successful, transmitting the information to the user.
